(19) United States
(12) Patent Application Publication
(10) Pub. No.: US 2026/0026641 A1
(43) Pub. Date: Jan. 29, 2026

(54) STORAGE WALL SYSTEM WITH MAGNETIC BRACKET

(71) Applicant: Tatanka Racks, LLC, Cynwyd, PA (US)

(72) Inventors: Christian Welgs, Cynwyd, PA (US); Matt Danish, Cynwyd, PA (US)

(21) Appl. No.: 18/785,192

(22) Filed: Jul. 26, 2024

(51) Int. Cl. A47F 5/08; A47F 11/10

(52) U.S. Cl. CPC A47F 5/083; A47F 5/0006; A47F 5/0807; A47F 5/0823; A47F 5/0876; F16B 2200/83

(57) ABSTRACT

A slatwall storage system includes a wall and at least one bracket anchored to the wall using a magnet. The wall may include one or more slits, and the bracket includes a receiver for receiving an item and a lip for engaging in the one or more slits. The bracket includes the magnet mounted to the bracket, where the magnet is configured to be attracted to the wall and may be positioned adjacent to the wall for stabilizing the bracket at the wall. The bracket may be combined with additional brackets to support the item on the wall.

### BACKGROUND

### (a) Technical Field

The present disclosure relates to a system for storing items, more particularly, to a slatwall storage system including a wall and brackets anchored to the wall using magnets.

### (b) Description of the Related Art

Slatwalls, also known as slat walls, slotwalls, or slitwalls, are a type of wall fixture commonly used to organize and store various objects in a wide variety of applications. For example, slatwalls may be used to store tools, display merchandise, or hold exercise equipment, but can be used for many other purposes. Slatwalls may be installed in commercial and/or residential locations including basements or garages for storage of tools and other equipment, or can be provided in other indoor or outdoor locations.

Slatwalls typically include horizontal grooves or slats that extend across the wall lengthwise. The slats are configured to receive and hold hooks, brackets, shelves, or other fixtures. Slatwalls typically allow for flexible arrangement of various objects, and may be removed and reconfigured. Slatwalls additionally may help maximize wall space and storage. However, in some cases, the hooks or other fixtures that are held by the slats lack stability and are subject to slippage or easy removal. Brackets or other fixtures also have a limited weight which they can support. Additionally, there are aesthetic limitations, as some types of slatwalls may be seen as aesthetically undesirable.

The present disclosure relates to improvements of at least some of the above limitations and issues described above.

### SUMMARY

A slatwall storage system includes a wall and at least one bracket anchored to the wall using a magnet. The wall may include one or more slits, and the bracket includes a receiver for receiving an item and a lip for engaging in the one or more slits. The bracket includes the magnet mounted to the bracket, where the magnet is configured to be attracted to the wall and may be positioned adjacent to the wall for stabilizing the bracket at the wall. The bracket may be combined with additional brackets to support the item on the wall.

According to the present disclosure, a storage system may include: a wall including one or more slits; a bracket configured to support an item, the bracket including: a magnet; a receiver configured to receive the item; and a lip configured to be received by the one or more slits, where the magnet is configured to be attracted to the wall.

The magnet may be positioned adjacent to the wall and be configured to stabilize the bracket at the wall.

The magnet may be mounted to or embedded in the bracket.

The magnet may include a main body including the receiver. The lip may be offset relative to the main body of the bracket.

The wall may include a plurality of the slits extending transversely across the wall. The slits may be discontinuous across the wall.

The wall may be formed from a ferromagnetic material.

The wall may include lighting configured to illuminate the wall.

The wall may be formed from a sheet metal (e.g., having a gauge of approximately 10-16) and/or a polymeric material, such as nylon.

The bracket may be formed by 3D printing.

The receiver may include a hook.

According to the present disclosure, a bracket for supporting an item may include: a magnet configured to attract the bracket to a ferromagnetic material; a lip configured to be inserted into a slit of a wall; and a receiver configured to support the item.

The magnet may be configured to stabilize the bracket at the wall.

The magnet may be embedded within the bracket, or mounted to the bracket.

The bracket may include a main body including the receiver. The lip may be offset relative to the main body of the bracket.

The bracket may be formed from a polymeric material, such as nylon.

The bracket may be formed by 3D printing.

According to the present disclosure, a method of attaching a bracket to a wall may include steps of: inserting a lip of the bracket into a slit on the wall; and releasing the bracket and allowing a main body of the bracket to contact the wall, where the main body of the bracket may be configured to magnetically attract to the wall so as to anchor the bracket to the wall.

### BRIEF DESCRIPTION OF THE DRAWINGS

FIG. 1 is a perspective view of a system including a wall and one or more brackets for storing items in accordance with the present disclosure.

FIG. 2 is a side view of the system of FIG. 1.

FIG. 3 is a rear view of the system of FIG. 1.

FIG. 4 is a rear perspective view of a wall for use in a system for storing items in accordance with the present disclosure.

FIG. 5 is a perspective view of a bracket for use in a system for storing items in accordance with the present disclosure.

FIG. 6 is a rear perspective view of the bracket of FIG. 5.

FIG. 7 is a rear perspective view of the bracket of FIG. 5 including a magnet according to an embodiment.

FIG. 8 is a rear perspective view of the bracket of FIG. 5 including a magnet and a fastener according to another embodiment.

FIG. 9 is a front view of the wall of FIG. 4 including a bracket for holding an object.

FIG. 10 is a rear perspective view of a bracket in for use in a system for storing in accordance with the present disclosure.

FIG. 11 is a perspective sectional view of the bracket of FIG. 10.

FIGS. 12 through 17 are different types of brackets for use in a system for storing items in accordance with the present disclosure.

FIG. 18 is a perspective view of a system for storing items in accordance with the present disclosure that further includes a lighting system.

FIG. 19 is a shelf for use in a system for storing items in accordance with the present disclosure.

### DETAILED DESCRIPTION

In the various embodiments, the devices, methods, and systems of the present disclosure relate to slatwall storage systems. Specifically, the present disclosure relates to methods, systems, and components of slatwall storage systems and improvements thereof. In some aspects, the present disclosure relates to a highly customizable slatwall storage system capable of supporting weight using one or more brackets, where the brackets attach magnetically to a wall, and are capable of supporting a greater amount of weight in a stable manner as compared to conventional slatwall storage systems. Additionally, the slatwall storage system of the present disclosure includes aesthetic improvements.

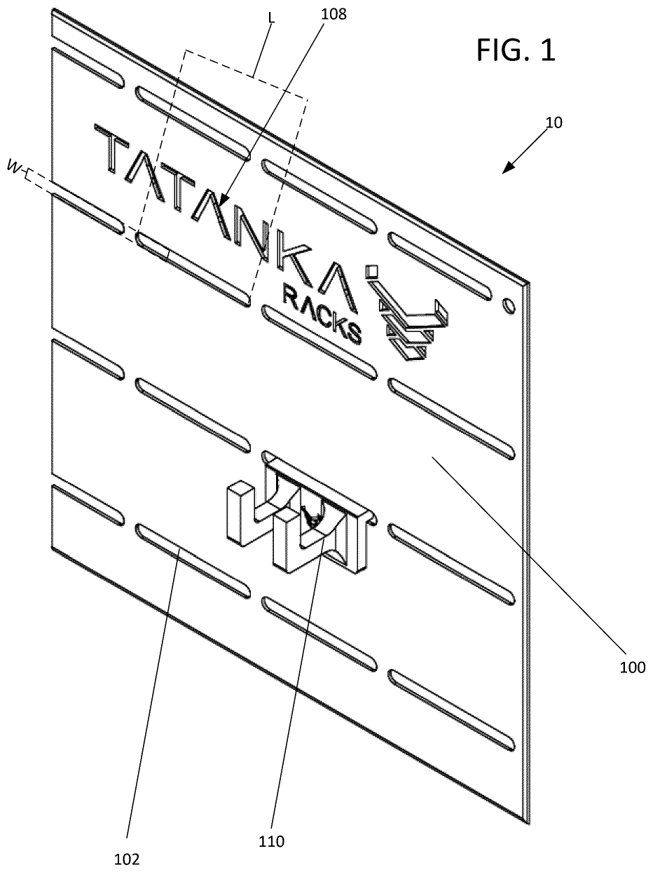

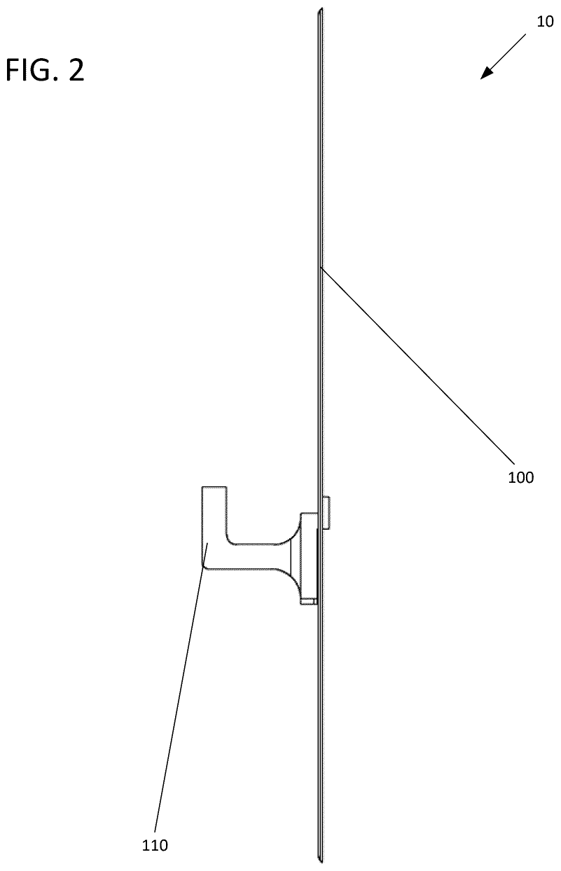

Referring to FIGS. 1 through 3, a system 10 for storing items in accordance with the present disclosure is depicted. The system 10 includes at least a wall 100 and a bracket 110. In FIG. 1, a single bracket 110 is depicted, but multiple brackets may be configured to be supported at different locations on the wall 100. The brackets 110 may be provided with similar or different sizes, shapes, and/or orientations, and may be arranged in desired locations, e.g., in different slits, slots, or slats, on the wall 100.

The wall 100 includes a plurality of slits 102 that are configured to removably receive the bracket 110. The wall 100 is preferably made of a malleable material that can be bent and machined using equipment such as a panel bender while retaining structural integrity, where the wall 100 is capable of holding heavy items or objects without buckling or deforming. Additionally, the wall 100 is preferably formed of a ferromagnetic material. For example, the wall 100 may be formed from hot rolled steel (HRS), a galvannealed sheet, cold rolled steel, or another suitable material. The wall 100 preferably has a thickness in a range of about 10 to 16 gauge. For example, the wall 100 may have a thickness of about 10 to 12 gauge, about 12 to 14 gauge, about 14 to 16 gauge, or another suitable thickness. Preferably, the wall 100 is coated via a painting process such as powder coating, zinc coating, conversion coating, anodization, electroplating or other process that protectively covers the wall 100 while retaining the ferromagnetic properties thereof.

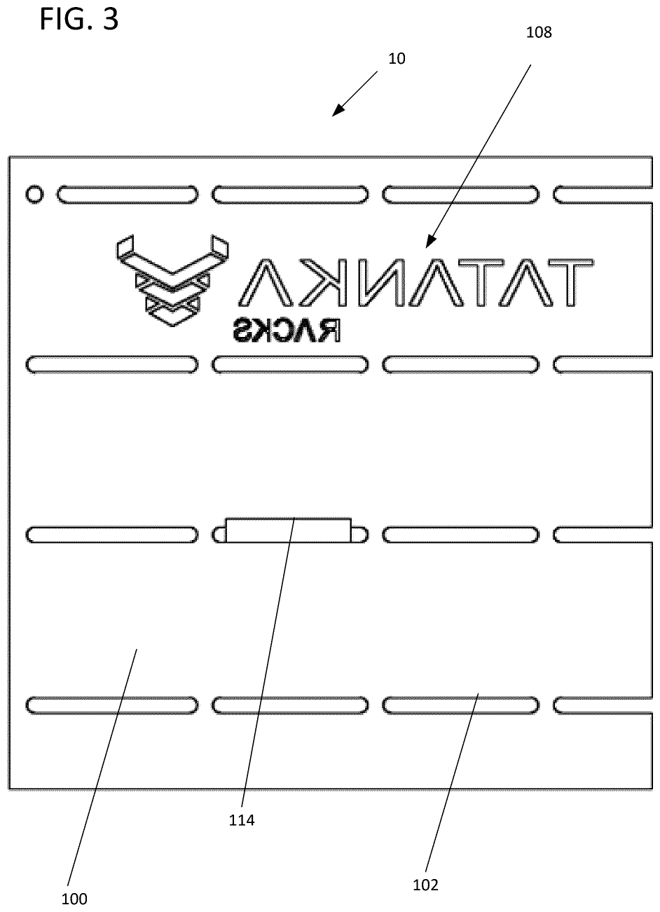

In some embodiments, the slits 102 may be elongated so as to extend across a part of or the entire wall 100 along a width W of the wall 100. As depicted, the slits 102 are discrete elongated slots that are configured to securely receive the bracket 110. The slits 102 as provided in discrete, separated, elongated slots enable the wall 100 to maintain structural integrity while presenting various flexible options and positions for securing the bracket 110. It will be appreciated that the slits 102 may be formed in a suitable shape for receiving the bracket 110 securely. For example, as shown in FIG. 3, a lip 114 of the bracket 110 is received on a rear portion of the wall 100.

As depicted, the slits 102 are stadium shaped, but in other examples the slits may be rectangular, circular, square, or a different suitable shape. In some embodiments, the slits 102 may be formed via one or more machining process. For example, the slits 102 may be formed with a CNC machine, and/or they may be formed by water cutting, laser cutting, or another suitable manufacturing procedure. The slits 102 have a width W and a length L, where the width W and the length L may vary depending on desired parameters of the wall 100. For example, for any particular arrangement of the slits 102 on the wall 100, the length L of one or more of the slits 102 may be about 4 inches, about 4.5 inches, about 5 inches, about 5.5 inches, or a different suitable length. The width W may be about 0.25 inches, about 0.5 inches, about 0.75 inches, about 1 inch, or a different suitable width. Additionally, the wall 100 may include a logo 108, e.g., artwork or other design. The logo 108 may be a design or other representation to denote the manufacturer, seller, or any person, place, or thing that may be appealing to the consumer such as a licensed trademark of a popular brand or sports team. The logo 108 may be made in a similar manner as the slits 102 as discussed above.

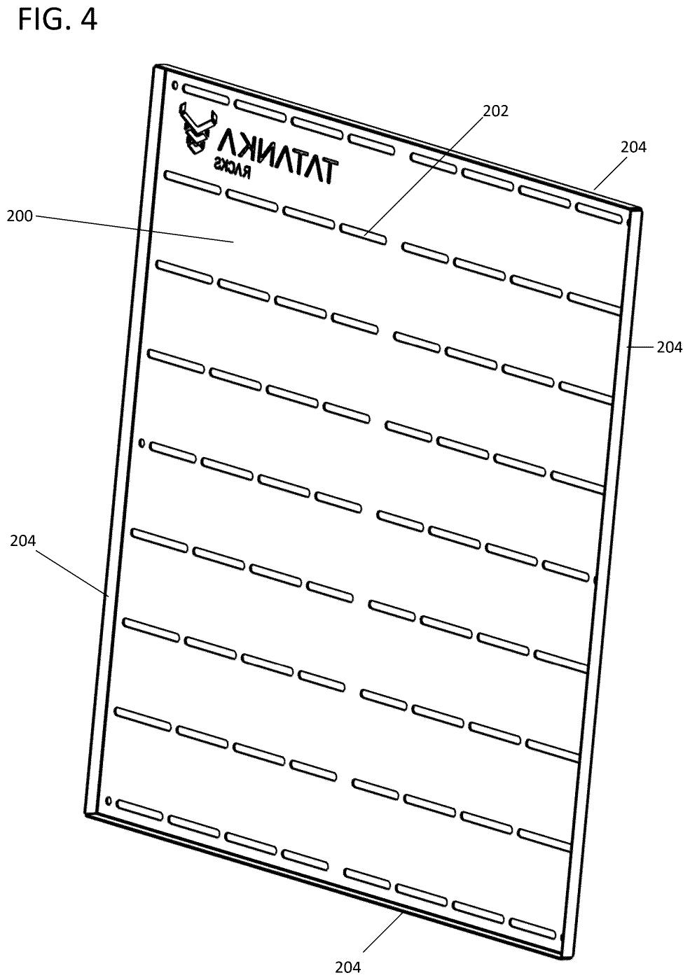

FIG. 4 depicts a wall 200 that is similar to the wall 100 and includes a plurality of slits 202 arranged in a manner that is similar to the slits 102 depicted in FIG. 1. The wall 200 differs from the wall 100 of FIG. 1 by including bent edges 204, which may improve structural integrity. Preferably the bent edges 204 extend around the perimeter of the wall 200 and at right angles relative to the wall 200. The bent edges 204 further extend from the rear side of the wall 200. The bent edges 204 also may be referred to as flanges or hems. The bent edges 204 may provide additional rigidity by delineating a frame around the wall 200 which evenly distributes stress on the wall 200. The bent edges 204 also may impart added stiffness, increased load bearing capabilities, and/or provide other benefits. The bent edges 204 further may allow for clearance of the bracket 110 (discussed in further detail below). The bent edges may extend about 0.25 inches, about 0.5 inches, about 0.75 inches, about 1 inch, or about 1.25 inches from the wall 100.

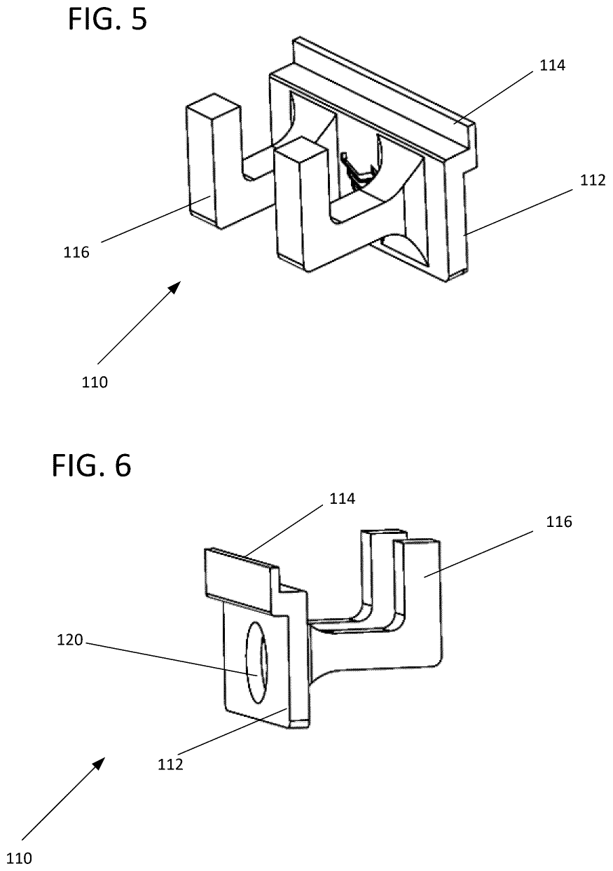

FIGS. 5 through 8 depict the bracket 110 in further detail. The bracket 110 includes a main body 112 including a lip 114 that extends therefrom and a holding member 116. The lip 114 is configured to be inserted into one of the slits 102, and the main body 112 is configured to rest against the wall 100. The holding member 116, depicted with first and second hooks, is configured to receive and hold objects that are stored on the wall 100.

The lip 114 is generally configured to extend parallel to the main body 112 and is offset from the body by approximately the same thickness as the wall 100 such that the lip 114 contacts the side of the wall 100 opposite to the holding members such that the main body 112 and holding member 116 are flush with a front side of the wall 100. The main body 112 includes an opening 120. The lip 114 may be offset from the main body 112 by about 0.2 to 0.3 inches, about 0.3 to 0.4 inches, about 0.4 to 0.5 inches or a different suitable offset.

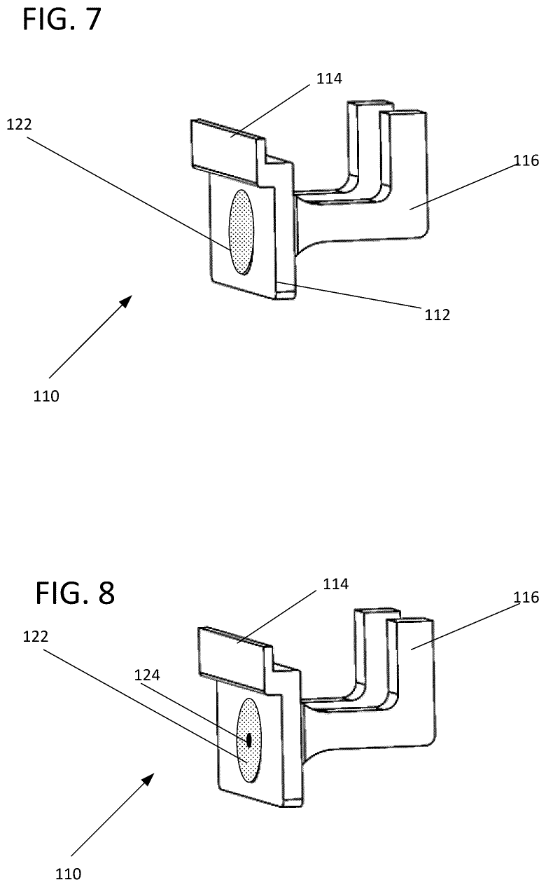

The opening 120 is configured to receive a magnet 122 (see FIGS. 7 and 8). The magnet 122 optionally may be connected to the opening 120 via a fastener 124. The fastener 124 may be a screw, adhesive or other suitable fixation mechanism. By virtue of the magnet 122 and magnetic properties of the wall 100, the magnet 122 is configured to be attracted to the wall 100. In some embodiments, the magnet 122 has a pulling force of approximately 120 pounds. In other examples, the magnet 122 is configured to have a pulling force of approximately 100 pounds to 110 pounds, about 110 pounds to 120 pounds, about 120 pounds to 130 pounds, or a different suitable pulling force.

In some embodiments, the magnets 122 are neodymium magnets, iron nitride magnets, ceramic magnets, ferrite magnets, or a different suitable magnet. The magnet 122, due to its pulling forces, securely holds the bracket 110 to the wall 100 without slipping. The magnet 122 provides an additional benefit of allowing the bracket 110 to hold extra weight in comparison to a bracket without a magnet. For example, the bracket 110 may hold a weight of about 110 pounds, or another amount corresponding to the pulling force of the magnet 122. In contrast, conventional brackets or other devices configured to be connected to slatwalls typically can support only lesser weights of up to about 50 pounds.

The magnet 122 also may simplify attachment of the bracket 110 to the wall 100. A user can simply place the lip 114 within the slit 102 and release the bracket 110. The bracket 110 will then be attracted by magnetic force to the wall 100 and remain securely in place. When removing the bracket 110, a user may lift the main body 112 of the bracket 110 and remove the lip 114 from the slit 102.

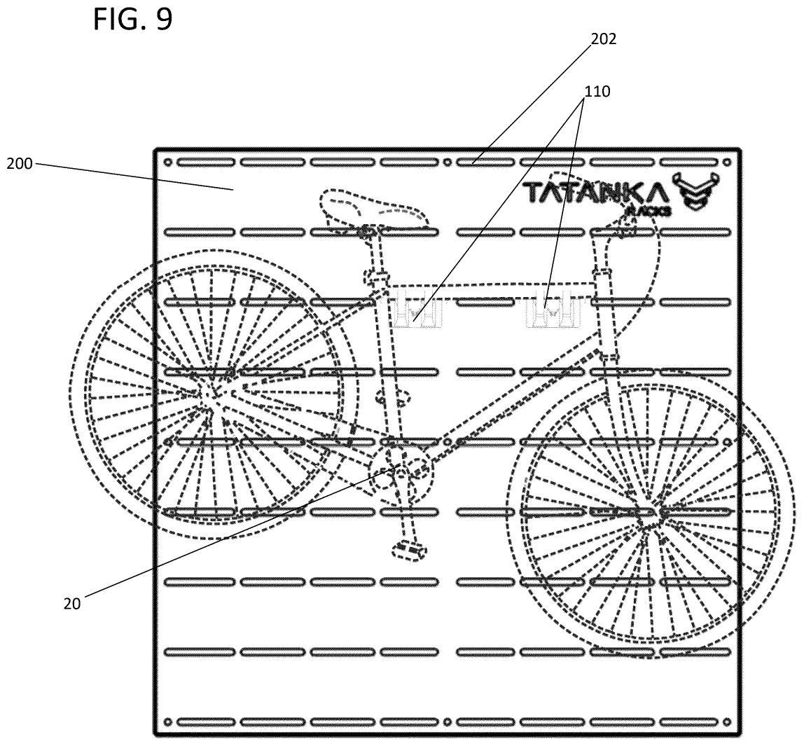

FIG. 9 depicts the wall 200 in an exemplary arrangement for holding an object. The wall 200 includes brackets 110 attached at the slits 202. The brackets 110 are attached, as discussed above, by inserting the lip of each bracket 110 into at least one of the slits 202. After the lip is inserted, the main body 112 of the bracket 110 may then be released allowing for the main body 112 to contact the wall 200. As discussed above, the main body 112 is attracted to the wall 200 via magnetism. The bracket 110 may then be used to hold various items. Depending on the type of bracket 110 (additional brackets are discussed below) and size of the object that is being held, multiple brackets 110 may be used. Additionally, the position of the bracket 110 may be changed.

As depicted in FIG. 9, the brackets 110 are being used to hold an object 20. The brackets 110 are arranged such that multiple brackets 110 are configured to hold the object 20. As depicted in FIG. 9, the object 20 is a bicycle that is supported by two brackets 110. In some examples, depending on the size, weight, and/or orientation of the object, multiple different objects may be supported by brackets 110 on the wall 200. Alternative brackets for holding various objects are discussed below. The various brackets discussed herein may be used similarly to the bracket 110. It will also be appreciated that the brackets discussed herein may be rearranged to support different objects or to change the orientation or positioning of the object that is being held.

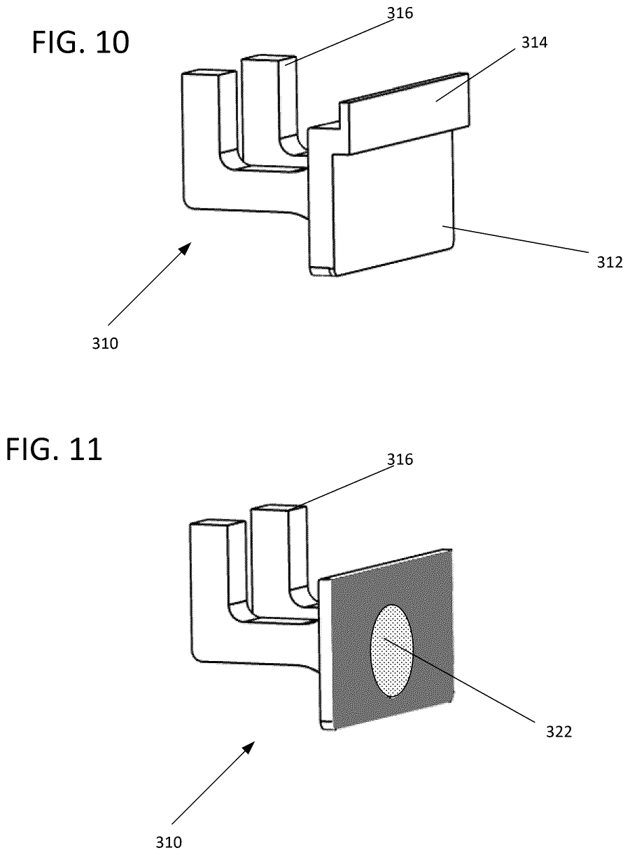

Referring to FIGS. 10 and 11, an alternative bracket 310 is depicted. The bracket 310 is similar to the bracket 110 and includes a main body 312, a holding member 316, and a lip 314. The bracket 310 includes a magnet 322 that is embedded within the main body 312. In some examples, the bracket 310 is manufactured by 3-D printing and the magnet 122 is inserted partially through the process. FIG. 11 depicts a sectional view of the bracket 310 showing the magnet 322 embedded within. The bracket 310 may alternatively be made using injection molding or a different suitable process. The bracket 110 may also be made from a similar process.

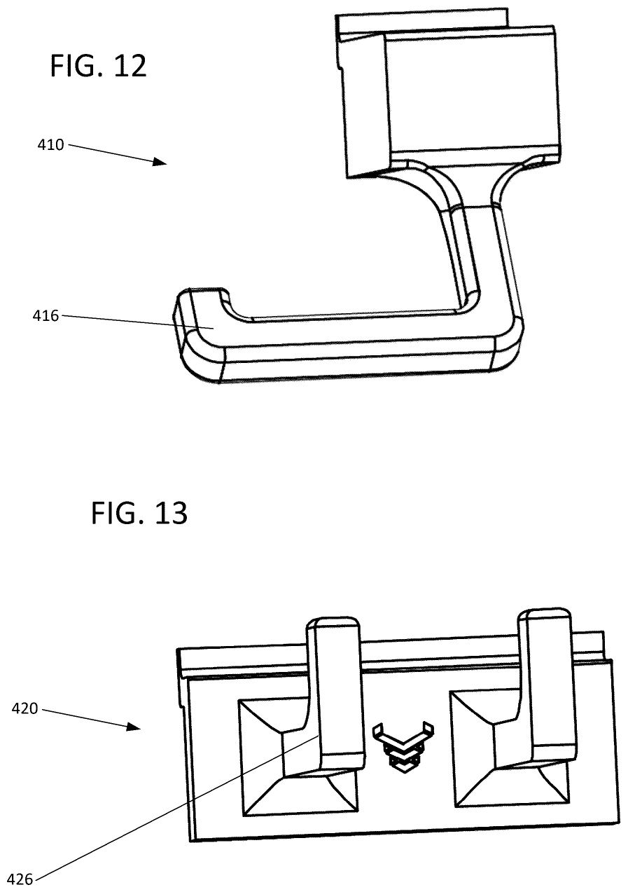

In some embodiments, the brackets 110, 310 may be formed from nylon, polylactic acid (PLA), acrylonitrile butadiene styrene (ABS), polyethylene terephthalate glycol (PETG), resins, composites or other suitable materials. It will be appreciated that other brackets (discussed in further detail below in reference to FIGS. 12 through 17) may be formed from similar materials or methods as discussed above. Additionally, each bracket discussed below may include a magnet either embedded with or within an opening as described above.

Referring now to FIGS. 12 through 17, brackets including alternative holding members are shown. The depicted brackets, aside from the holding members, are similar to the brackets 110, 310 and may be manufactured in a similar manner and from similar materials. The following description will therefore mainly focus on the holding members.

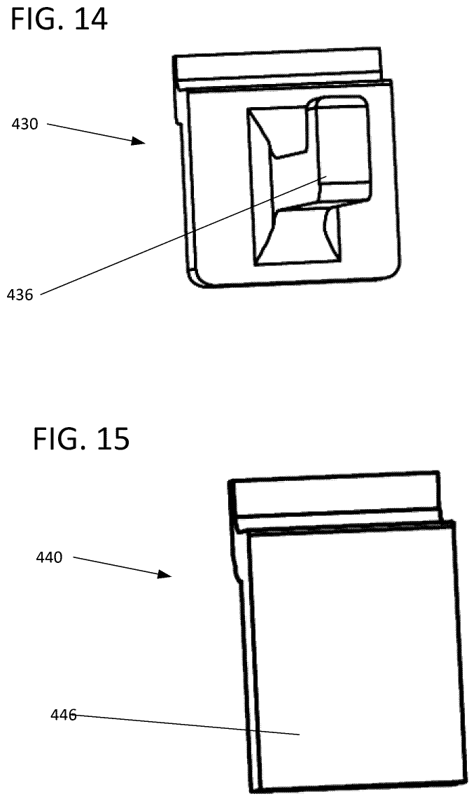

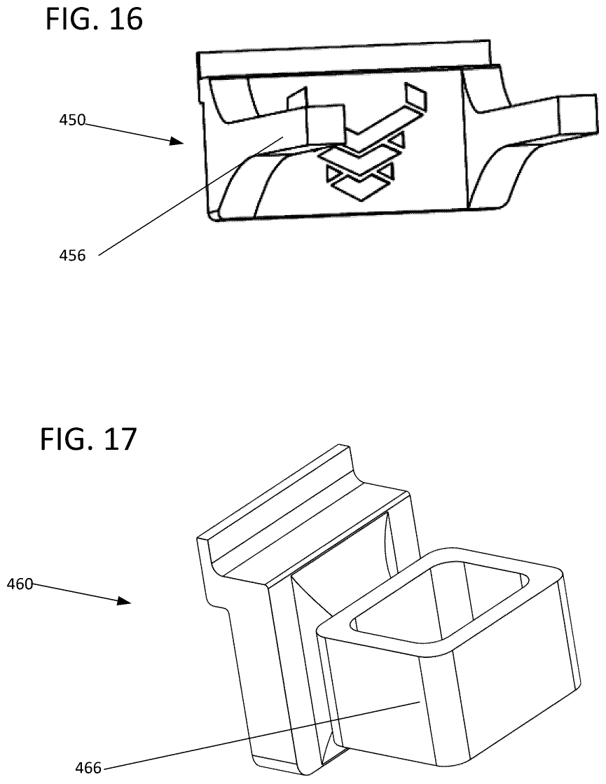

Referring to FIG. 12, a bracket 410 including a holding member 416 is depicted. The holding member 416 is C-shaped and configured to hold an object against a wall (e.g., wall 100, 200). The holding member 416 may be useful for holding an elongated object such as a golf club, hockey stick, or other object. Referring to FIG. 13, a bracket 420 having a holding member 426 is depicted. The holding member 426 is similar to the holding members 116, 316. The holding member 426 includes two J-shaped members which may hold a device such as a drill, a hammer, tennis racket, or a different suitable device. FIG. 14 depicts a bracket 430 having a holding member 436. The holding member 436 includes a single J-shaped member. The holding member 436 may hold any device discussed above or may be used in conjunction with a different similar holding member 436. FIG. 15 depicts a bracket 440 that includes a holding member 446. The holding member 446 is generally flat and may include a magnet. Alternatively, the holding member 446 may be configured to receive a screw. FIG. 16 depicts a bracket 450 including a holding member 456. The holding member 456 is depicted as generally perpendicular to the main body of the bracket 450. The holding member 456 may hold an object such as the devices discussed above or a different suitable device. FIG. 17 depicts a bracket 460 with a holding member 466. The holding member 466 is configured as a rectangle with a slot therethrough. A device may be inserted into the hole of the holding member 466 to be held. The holding member 466 may hold any device as discussed above or another suitable device. It will be appreciated that other brackets and holding members are additionally possible. Additionally, it will be appreciated that the holding member discussed herein and other holding members may hold other devices such as a television, biking equipment, other sports equipment, gym equipment or any other device that is required to be supported, held, and/or suspended on a wall.

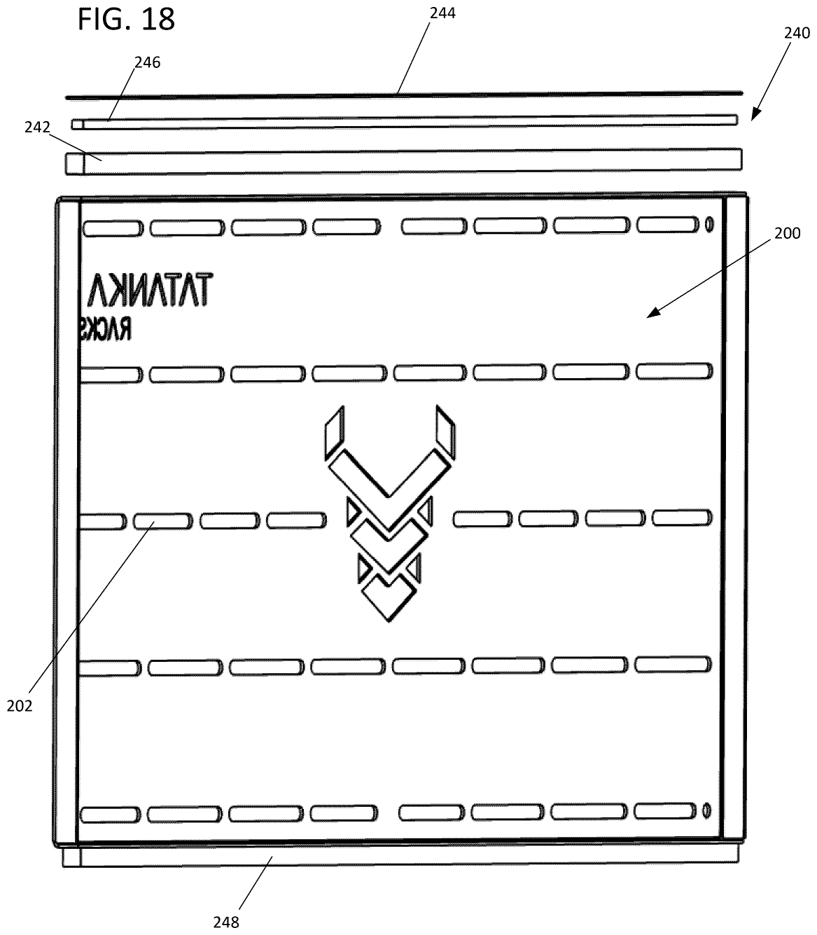

Referring to FIG. 18, a system for storing items includes a wall having bent edges. The size of the wall is slightly different from the wall 200 shown in FIG. 4, but is otherwise similar, and thus like reference numbers will be used. The wall 200 depicted in FIG. 18 is exemplified by including one or more light assemblies. As shown in FIG. 18, the wall 200 includes a top lighting assembly 240. An exploded view of the top lighting assembly 240 is depicted at the upper portion of the wall 200 and positioned on a bent edge 204. The top lighting assembly 240 includes a housing 242, a cover 244, and a light strip 246. The light strip 246 is configured to be disposed within the housing 242, and the cover 244 is configured to removably attach to the housing 242 for access to the light strip 246. The light strip 246 may be configured to provide lighting above, below, or through the wall 200. The light strip 246 may be an LED light strip, an RGB light strip, or a single color light strip. The lighting provided by the light strip 246 may provide aesthetic benefits. The wall 200 is additionally depicted as including a bottom lighting assembly 248 on the bottom bent edge 204 of the wall 200. In some embodiments, the bottom lighting assembly 248 is battery powered, powered via a chord, or a different suitable power source.

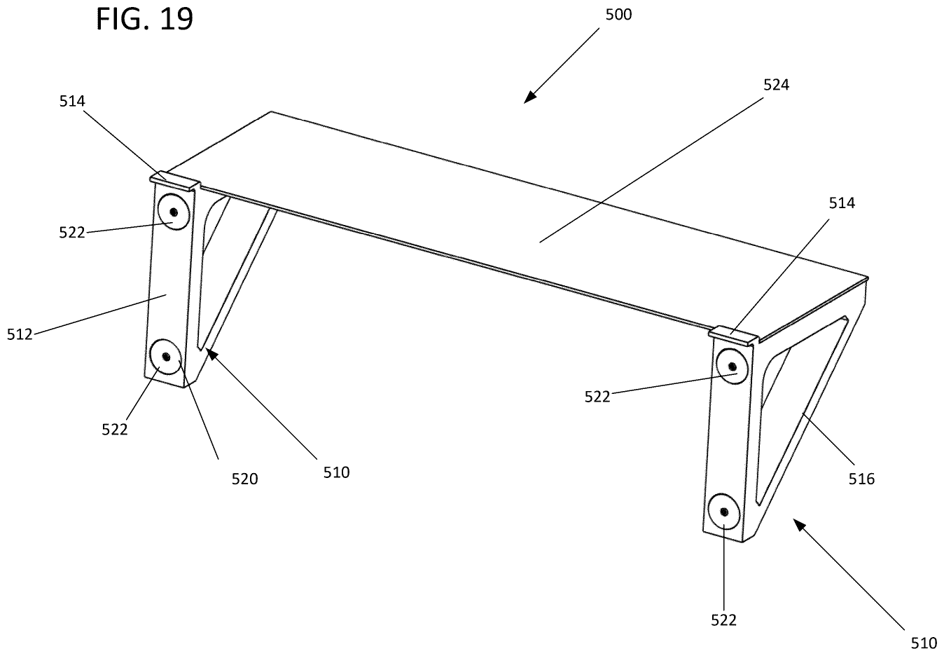

Referring to FIG. 19, a shelving assembly 500 is depicted. The shelving assembly 500 includes first and second brackets 510. The brackets 510 are similar to the bracket 110 and include a lip 514, a main body 512, and openings 520 that receive a magnet 522. The brackets 510 include a holding member 516 that is generally configured to be perpendicular to the wall it is attached to. The holding member 516 of each of the brackets 510 support opposite sides of a shelf 524. The brackets 510 may be inserted into a wall similarly to each of the brackets discussed above and the shelf 524 may be used as a conventional shelf.

Other advantages of the present disclosure can be apparent to those skilled in the art from the foregoing specification. Accordingly, it will be recognized by those skilled in the art that changes, or modifications may be made to the above-described embodiments without departing from the broad inventive concepts of the disclosure. It should therefore be understood that this disclosure is not limited to the particular embodiments described in this document but is intended to include all changes and modifications that are within the scope and spirit of the disclosure as defined in the claims.

The term “approximately,” when used in connection with a numeric value, is intended to include values that are close to, but not exactly, the number. For example, in some embodiments, the term “approximately” may include values that are within +/−5 percent of the value.

This disclosure is not limited to the particular systems, methodologies or protocols described, as these may vary. The terminology used in this description is for the purpose of describing the particular versions or embodiments only and is not intended to limit the scope. It will be understood that terms such as “same,” “equal,” “planar,” or “coplanar,” as used herein when referring to orientation, layout, location, shapes, sizes, amounts, or other measures do not necessarily mean an exactly identical orientation, layout, location, shape, size, amount, or other measure, but are intended to encompass nearly identical orientation, layout, location, shapes, sizes, amounts, or other measures within acceptable variations that may occur, for example, due to manufacturing processes. The term “substantially” may be used herein to emphasize this meaning, unless the context or other statements clearly indicate otherwise. For example, items described as “substantially the same,” “substantially equal,” or “substantially planar,” may be exactly the same, equal, or planar, or may be the same, equal, or planar within acceptable variations that may occur, for example, due to manufacturing processes and/or tolerances. The term “substantially” may be used to encompass this meaning, especially when such variations do not materially alter functionality. As used herein, the term “proximal” means closest to the operator (less into the body) and “distal” means furthest from the operator (further into the body). In positioning a medical device from a downstream access point, distal is more upstream and proximal is more downstream.

It will be understood that various modifications may be made to the embodiments disclosed herein. Likewise, the above disclosed methods may be performed according to an alternate sequence. Therefore, the above description should not be construed as limiting, but merely as exemplification of the various embodiments. Those skilled in the art will envision other modifications within the scope and spirit of the claims appended hereto.

What is claimed is:

1. A storage system comprising:
a wall comprising one or more slits;
a bracket configured to support an item, the bracket comprising:
a magnet;
a receiver configured to receive the item; and
a lip configured to be received by the one or more slits,
wherein the magnet is configured to be attracted to the wall.

2. The storage system of claim 1, wherein the magnet is positioned adjacent to the wall and is configured to stabilize the bracket at the wall.

3. The storage system of claim 1, wherein the magnet is mounted to the bracket.

4. The storage system of claim 1, wherein the bracket further comprises a main body including the receiver.

5. The storage system of claim 4, wherein the lip is offset relative to the main body of the bracket.

6. The storage system of claim 1, wherein the wall comprises a plurality of the slits extending transversely across the wall.

7. The storage system of claim 8, wherein the slits are discontinuous across the wall.

8. The storage system of claim 1, wherein the wall is formed from a ferromagnetic material.

9. The storage system of claim 1, wherein the wall further comprises lighting configured to illuminate the wall.

10. The storage system of claim 1, wherein the wall is formed from a sheet metal or a polymeric material.

11. The storage system of claim 1, wherein the bracket is formed by 3D printing.

12. A bracket for supporting an item, the bracket comprising:
a magnet configured to attract the bracket to a ferromagnetic material;
a lip configured to be inserted into a slit of a wall; and
a receiver configured to support the item.

13. The bracket of claim 12, wherein the magnet is configured to stabilize the bracket at the wall.

14. The bracket of claim 12, wherein the magnet is embedded within the bracket.

15. The bracket of claim 12, wherein the magnet is mounted to the bracket.

16. The bracket of claim 12, wherein the bracket further comprises a main body including the receiver.

17. The bracket of claim 16, wherein the lip is offset relative to the main body of the bracket.

18. The bracket of claim 12, wherein the bracket is formed from a polymeric material.

19. The bracket of claim 16, wherein the bracket is formed by 3D printing.

20. A method of attaching a bracket to a wall, the method comprising:
inserting a lip of the bracket into a slit on the wall; and
releasing the bracket and allowing a main body of the bracket to contact the wall,
wherein the main body of the bracket is configured to magnetically attract to the wall so as to anchor the bracket to the wall.
